(19) United States
(12) Patent Application Publication
(10) Pub. No.: US 2015/0260639 A1
(43) Pub. Date: Sep. 17, 2015

(54) SELF-CLEANING OPTICAL PROBE

(71) Applicant: Advanced Sensors Limited, Carrickfergus (GB)

(72) Inventors: Khalid Thabeth, Newtownabbey (GB); Frank Lunney, Belfast (GB)

(73) Assignee: Advanced Sensors Limited, Carrickfergus (GB)

(21) Appl. No.: 14/678,579

(22) Filed: Apr. 3, 2015

Related U.S. Application Data
(63) Continuation of application No. 13/502,766, filed on Jun. 26, 2012, now abandoned.

(30) Foreign Application Priority Data
Oct. 21, 2009 (GB) 200918434.2

(51) Int. Cl. G01N 21/15; B08B 7/02; G01N 21/64

(52) U.S. Cl. CPC G01N 21/15; G01N 21/64; B08B 7/028; G01N 2021/154

(57) ABSTRACT

An optical probe comprising an elongate hollow body having an internal chamber for receiving an optical sensor and/or an light emission device, such as one or more optical fibres, an optical window being provided at a first end of the hollow body, said optical window defining a wall of said internal chamber for transmitting light therethrough, and an ultrasonic transducer provided at a second end of the elongate body opposite said first end for cleaning said optical window via ultrasonic vibrations, wherein said ultrasonic transducer is provided with an entry aperture extending through the ultrasonic transducer, through which entry aperture optical fibres, cables or wires may pass to enter said internal chamber.

This invention relates to a self cleaning optical carrier probe and in particular to a self cleaning optical probe for oil in water sensors.

There are many applications that require measurement of the quantity of oil that is present in a liquid. For example, in pipes leading from oil production or refining facilities or the like it may be required to measure the amount of oil that is present in the liquid (mainly water) flowing in the pipes. To this end it is known to provide an in-line measurement apparatus which measures the amount of oil that is present.

Oil has a natural fluorescence and so, commonly, such measurement apparatus measure the quantity of oil by the detection of fluorescence. Devices that detect and/or measure fluorescence are commonly referred to as fluorometers. A fluorometer usually includes a light source for causing fluorescence in a target substance and a detector for measuring the resultant fluorescence.

A typical in-line fluorometer has a measurement window through which the excitation light source is transmitted into a measurement region and through which the resultant fluorescent light is received by the fluorometer. One problem with such fluorometers is the fouling of the measurement window by substances within the measurement region. This problem may be addressed by using an ultrasonic probe with an embedded optical window. The window will be cleaned by the ultrasonic cavitations created by the ultrasonics. The probe will act as a carrier probe providing a clean viewing window of the medium by optical fibres, sensors or cameras.

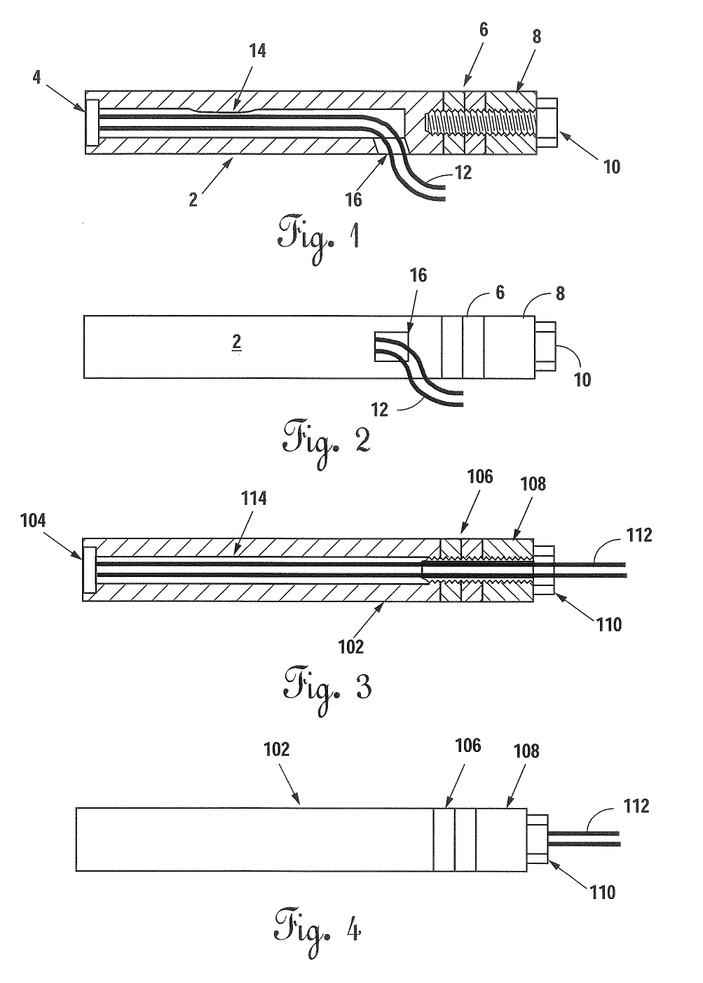

FIGS. 1 and 2 show a conventional ultrasonic probe, comprising an elongate hollow probe shaft 2 (known as a sonitrode) having a sapphire window 4 at a distal end thereof. Ceramic transducer discs 6 are mounted on an opposite end of the probe shaft, located between a back mass 8 and the probe shaft 2. A bolt 10 passes through the rear of the back mass 8 and through the ceramic transducer discs 6 into the near end of the probe shaft 2 to secure the ceramic discs 6 and back mass 8 to the probe shaft 2. The bolt 10 is tightened to a specific design torque.

Optical fibres and electrical leads 12 are passed into a central channel 14 of the hollow probe shaft 2 through an entry slot 16 cut through side of the probe shaft 2. Such entry slot 16 creates a high impedance path for the ultrasonic transmission from the ceramic transducer discs 6 through the probe shaft 2 to the sapphire window 4. This impedance absorbs the sonic energy creating a local heating of the probe. The resulting issues are as follows:
1. Poor energy transmission from the ceramic transducer discs 6 to the sapphire window 4;
2. Poor impedance matching through the probe shaft 2 causes an unstable transmission path and an unstable resonance medium, as a result tuning of the probe shaft 2 is difficult and unstable;
3. The heat generation at the entry slot 16 can cause melting or fracturing of the optical fibres, copper wires or other cables 12 passing therethrough.

The present invention obviates these problems by providing an optical probe comprising an elongate hollow body having an internal chamber for receiving an optical sensor and/or an light emission device, such as one or more optical fibres, an optical window being provided at a first end of the hollow body, said optical window defining a wall of said internal chamber for transmitting light therethrough, and an ultrasonic transducer provided at a second end of the elongate body opposite said first end for cleaning said optical window via ultrasonic vibrations, wherein said ultrasonic transducer is provided with an entry aperture extending through the ultrasonic transducer, through which entry aperture optical fibres, cables or wires may pass to enter said internal chamber.

Preferably said aperture extends substantially coaxially with respect to the longitudinal axis of said elongate body.

Preferably said ultrasonic transducer comprising one or more ceramic transducer elements mounted against said second end of said elongate body and a reaction mass mounted against said one or more ceramic transducer elements.

Preferably said ultrasonic sensor is secured to the second end of said elongate body by means of a fastener, preferably a threaded fastener such as a bolt, passing therethrough. Preferably said fastener is provided with a hole defining said entry aperture. In a preferred embodiment, said fastener may comprise a hollow bolt or stud having an axial hole extending therethrough defining said entry aperture.

By providing an entry aperture through said ultrasonic transducer rather than through a side of the elongate body, the abovementioned problems associated with the prior art are avoided.

Preferably one or more light guides, such one or more optical fibres, extend through said entry aperture into said chamber within the hollow body of the optical sensor.

At least a portion of the hollow body of the optical probe may be lined or coated internally with a suitable lining to protect optical fibres and other cables or wires passing therethrough. In one embodiment the optical probe may be lined with an acetyl lining.

In one embodiment, said elongate hollow body comprises a tubular member, said chamber being defined by an internal bore of said tubular member. Said ultrasonic transducer, preferably comprising one or more ceramic transducer discs and a tubular reaction mass, may be mounted coaxially with said tubular member and may be secured thereto by means of a hollow bolt extending through the ultrasonic transducer.

An embodiment of the present invention will now be illustrated, by way of example, with reference to the accompanying drawings, in which:

FIG. 1 is a longitudinal sectional view through a known ultrasonic probe;

FIG. 2 is a side view of the ultrasonic probe of FIG. 1;

FIG. 3 is a longitudinal sectional view through an ultrasonic probe in accordance with an embodiment of the present invention; and

FIG. 4 is a side view of the ultrasonic transducer of FIG. 3.

As shown in the drawings, an ultrasonic probe in accordance with an embodiment of the present invention comprises a hollow cylindrical probe shaft 102 defining a central channel 114 for receiving optical sensors and/or light transmission devices, such as optical fibres, and having a sapphire window 104 at a distal end thereof, ceramic transducer discs 106 being mounted on an opposite end of the probe shaft, located between a back reaction mass 108 and the probe shaft 102. A hollow bolt 110 passes through the rear of the back mass 108 and through the ceramic transducer discs 106 into the rear end of the probe shaft 102 to secure the ceramic discs 106 and back mass 108 to the probe shaft 102.

Optical fibres and electrical leads 112 are passed into the central channel 114 the hollow probe shaft 102 through the centre of the hollow bolt 110, avoiding the need for any discontinuities in the wall of the probe shaft 102 which might lead to high impedance paths for the ultrasonic transmission from the ceramic transducer discs 106 through the probe shaft 102 to the sapphire window 104.

The clamping of the ceramic discs 106 between the back mass 108 and the probe shaft 102 is performed unconventionally with a hollow bolt 110 that has a channel through the centre. The above unconventional method of clamping the ceramic discs 106 negates the requirement for an entry slot, as it creates an extension of the channel 114 through the probe, this provides the following benefits:
1. Uniform conductance through the probe creates an efficient stable transmission path from the ceramic discs through to the sapphire window;
2. Efficient transmission through the probe, does not generate any hot spots that may affect optical fibres or copper wires extending into and through the probe shaft 102;
3. Ease of insertion and extraction of optical fibres, copper wire or any other medium or device into and out of the probe shaft 102;
4. Manufacture, deployment and maintenance may be greatly eased, again reducing the possibility of damage to the Optical Fibre, Copper Wires or other.

The probe may be lined with an acetyl ling to absorb any sonic sock that may be caused by the ultrasonic transducer disc 106, this in turn protects the optical fibres, copper wires or other devices located within the channel 114 of the probe shaft 102.

Such a probe construction in accordance with the present invention facilitates the insertion of numerous devices e.g. optical sensors, cameras, light sources etc. effectively creating a generic self cleaning carrier probe that will facilitate the insertion of various devices into fluid environments, negating the need for additional routine cleaning.

The invention is not limited to the embodiment(s) described herein but can be amended or modified without departing from the scope of the present invention

1. An optical probe comprising an elongate hollow body having an internal chamber for receiving an optical sensor and/or a light emission device, such as one or more optical fibres, an optical window being provided at a first end of the hollow body, said optical window defining a wall of said internal chamber for transmitting light therethrough, and an ultrasonic transducer provided at a second end of the elongate body opposite said first end for cleaning said optical window via ultrasonic vibrations, wherein said ultrasonic transducer is provided with an entry aperture extending through the ultrasonic transducer, through which entry aperture optical fibres, cables or wires may pass to enter said internal chamber, said ultrasonic transducer is secured to the second end of said elongate body by means of a threaded fastener passing therethrough, said fastener being provided with a longitudinal hole defining said entry aperture;
said aperture extends substantially coaxially with respect to the longitudinal axis of said elongate hollow body;
said ultrasonic transducer comprises one or more ceramic transducer elements mounted against said second end of said elongate hollow body and a reaction mass mounted against one or more of said ceramic transducer elements;
said optical fibres extending through said entry aperture into said internal chamber to said optical sensor; and
said hollow body being lined with an acetyl lining.

2-16. (canceled)
